(19) United States
(12) Patent Application Publication
(10) Pub. No.: US 2015/0286377 A1
(43) Pub. Date: Oct. 8, 2015

(54) Method and Device for Enlarging Mobile Application Edit Box Based on Event Monitor

(71) Applicant: ZTE CORPORATION, Shenzhen, Guangdong (CN)

(72) Inventors: Guiliang Qu, Shenzhen (CN); Yong Yang, Shenzhen (CN); Bin Wang, Shenzhen (CN)

(73) Assignee: ZTE CORPORATION, Shenzhen City, Guangdong Province (CN)

(21) Appl. No.: 14/441,870

(22) PCT Filed: Aug. 29, 2013
(86) PCT No.: PCT/CN2013/082580

§ 371 Date: May 11, 2015

(30) Foreign Application Priority Data
Nov. 12, 2012 (CN) 201210448700

(51) Int. Cl. G06F 3/0484; G06F 3/0488

(52) U.S. Cl. CPC G06F 3/04845; G06F 3/04842; G06F 3/04847; G06F 3/04886

(57) ABSTRACT

A method and apparatus for enlarging a mobile application edit box based on event monitor relate to the field of mobile applications. The method includes: after monitoring and intercepting a user input event of an original mobile application edit box, a mobile terminal creating an native interface of the mobile application; and enlarging and redrawing the original mobile application edit box in the native interface to obtain a new mobile application edit box suitable for the user input, which is supplied to the user to input information. The embodiments of the present document can save the time for the user to input information and improve user experience of information input.

### TECHNICAL FIELD

The present document relates to the field of mobile applications, and in particular, to a method for enlarging a mobile application edit box based on event monitor and a related apparatus.

### BACKGROUND

With the rapid development of network technologies, people gradually like and get used to use handheld mobile terminals such as mobile phones, PDAs etc. to chat online, send emails, tweet, browse webs, apply a search engine for query or playing games etc., and in this process, users of the mobile application terminals necessarily face a large amount of data input.

The mobile application terminals, mostly such as mobile phones, have relatively small screens. After the web pages are optimized and rearranged, the original edit box will be optimized according to the size of the screen, which may lead to an extremely small edit box in the mobile application, and in the process of information input, the input contents cannot be accurately and clearly viewed.

Currently, the mobile application terminals, mostly such as mobile phones, have small screens, and the positions and contents which can be used for display are very limited, which brings great inconvenience to users during information input. This undoubtedly becomes the biggest obstacle to hinder the promotion and popularization of mobile applications.

### SUMMARY

The purpose of the present document is to provide a method and apparatus for enlarging a mobile application edit box based on event monitor, which can better solve the problem of difficulty in input due to an extremely small edit box in the mobile applications.

According to an aspect of the present document, a method for enlarging a mobile application edit box based on event monitor is provided, comprising:

after monitoring and intercepting a user input event of an original mobile application edit box, a mobile terminal creating an native interface of the mobile application; and

enlarging and redrawing the original mobile application edit box in the native interface to obtain a new mobile application edit box suitable for the user input, which is supplied to the user to input information.

Preferably, the method further comprises:

implementing an enlarging process on the native interface according to a preset local enlargement proportion.

Preferably, the method further comprises:

implementing enlarging and redrawing processes on the original mobile application edit box in the enlarged native interface according to the preset input enlargement proportion.

Preferably, if the input enlargement proportion is not preset, implementing adaptive enlarging and redrawing processes on the original mobile application edit box according to the enlarged native interface.

Preferably, the method further comprises:

implementing enlarging and redrawing processes on a touch keyboard for information input and/or a font of information input by a user in a new mobile application edit box according to the input enlargement proportion or the enlarged native interface.

Preferably, the method further comprises:

rewriting the user input information in the new mobile application edit box into the original mobile application edit box and closing the native interface.

According to another aspect of the present document, an apparatus for enlarging a mobile application edit box based on event monitor is provided, comprising:

an edit box input event monitor module, configured to monitor and intercept a user input event of a mobile application edit box; and

an edit box redrawing event monitor module, configured to, after monitoring and intercepting the user input event, newly create an native interface of the mobile application, enlarge and redraw the original mobile application edit box in the native interface to obtain a new mobile application edit box suitable for the user input.

Preferably, the edit box redrawing event monitor module is further configured to implement an enlarging process on the native interface according to a preset local enlargement proportion.

Preferably, the edit box redrawing event monitor module is further configured to implement enlarging and redrawing processes on the original mobile application edit box and/or a touch keyboard and/or a font according to the preset input enlargement proportion or the enlarged native interface.

Preferably, the apparatus further comprises:

an edit box data interaction module, configured to rewrite the user input information in the new mobile application edit box into the original mobile application edit box and close the native interface.

Compared with the prior art, the embodiments of the present document have the following beneficial effects:

The embodiments of the present document makes great improvement in the experience of information input in the edit box, achieves the effect of displaying input information in the edit box, saves the time for the user to input information and improves user experience of information input.

### BRIEF DESCRIPTION OF DRAWINGS

FIG. 1 is a block diagram of the principle of a method for enlarging a mobile application edit box based on event monitor according to an embodiment of the present document;

FIG. 2 is a block diagram of a setting part of an apparatus for enlarging a mobile application edit box based on event monitor according to an embodiment of the present document;

FIG. 3 is a block diagram of an enlarging part of an apparatus for enlarging a mobile application edit box based on event monitor according to an embodiment of the present document;

FIG. 4 is a flowchart of an apparatus for enlarging a mobile application edit box based on event monitor according to an embodiment of the present document;

FIG. 5 is a flowchart of operations of a setting part according to an embodiment of the present document;

FIG. 6 is a presentation diagram of an edit box in a mobile application in the current stage according to an embodiment of the present document; and

FIG. 7 is a diagram of an effect after a terminal invokes the plug-in for redrawing according to an embodiment of the present document.

### PREFERRED EMBODIMENTS OF THE PRESENT DOCUMENT

The preferable embodiments of the present document will be described in detail below in conjunction with accompanying drawings. It should be understood that the preferable embodiments illustrated hereinafter are merely used for illustration and explanation of the present document, instead of limiting the present document.

The embodiments of the present document realize a method for enlarging an edit box in an operating system of a mobile terminal, which implements event binding of the edit box by monitoring and intercepting a user input event, without actively invoking the present document by another application. At the same time, the present document redraws the interface (the enlargement proportion of the newly drawn interface may be configured by a local enlarging module), and adaptively enlarges the edit box and the touch keyboard (the enlargement factor of the edit box and the touch keyboard may be set by an enlargement factor configuration module) in the new interface according to the size of the newly drawn interface in the mobile application, which are supplied to the user to input information

FIG. 1 is a block diagram of the principle of a method for enlarging a mobile application edit box based on event monitor according to an embodiment of the present document. As shown in FIG. 1, the following steps are comprised.

In step 10, after monitoring and intercepting a user input event of an original mobile application edit box, a mobile terminal newly creates a native interface of the mobile application.

Further, when the mobile terminal is started, a system broadcast will be issued, which has contents of ACTION_BOOT_COMPLETED (the string constant is represented as android.intent.action.BOOT _COMPLETED). When this message is captured, a plug-in apparatus according to the present document is started and operated. The user sets a local enlarging module, i.e., a user sets a local enlargement proportion of the plug-in. If the user implements the setting, the enlarged interface of the original mobile application edit box is set according to the local enlargement proportion set by the user. Otherwise, a default value is used to enlarge the enlarged interface of the original mobile application edit box to the whole screen of the terminal, so as to obtain the redrawn and enlarged interface. The user sets an enlargement factor configuration module, i.e., the user sets the input enlargement proportion of the original mobile application edit box, font, and touch keyboard in the redrawn and enlarged interface. If the user sets the proportion, the original mobile application edit box and/or font and/or touch keyboard are enlarged in the new interface according to the proportion set by the user. Otherwise, the proportion of the redrawn and enlarged interface will be adapted to enlarge the edit box and/or font and/or touch keyboard. When the user clicks on the edit box in the mobile application, it will trigger the edit box input event monitor module in the apparatus, which will monitor and intercept the user input event, and trigger monitor of the edit box redrawing event.

In step 20, the original mobile application edit box is enlarged and redrawn in the native interface to obtain a new mobile application edit box suitable for the user input, which is supplied to the user to input information.

Further, the mobile application newly creates, redraws, and enlarges a native interface of a mobile application through an edit box redrawing event monitor module, enlarges the newly created native interface according to the local enlargement factor preset by the user, and if the local enlargement proportion is not preset by the user, enlarges the native interface to the whole screen of the mobile terminal by default, to obtain a redrawn and enlarged interface. After the redrawn and enlarged interface is obtained, the original mobile application edit box, font and touch keyboard are enlarged adaptively in the redrawn and enlarged interface, and if the input enlargement proportion is not preset by the user, the original mobile application edit box and/or font and/or touch keyboard are adaptively enlarged by taking adaptive enlargement of the redrawn interface as a reference, to form a new enlarged and redrawn interface, which may be used as an information input interface of the user. After the user completes the information input, the mobile application rewrites the information input by the user in the information input interface into the original mobile application edit box by using an edit box data interaction module, and automatically closes the redrawn information input interface, so as to complete the data interaction process.

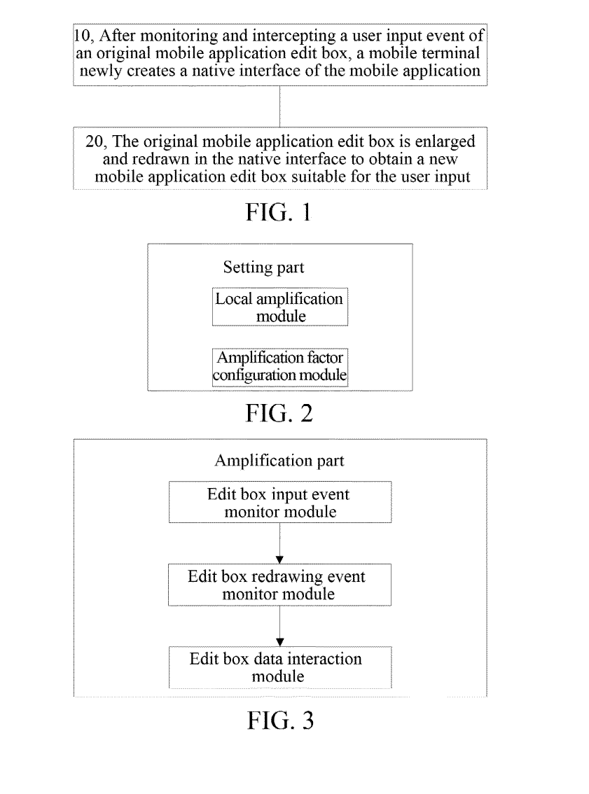

The embodiments of the present document further realize a plug-in apparatus in an operating system of a mobile terminal. After the operating system of the mobile terminal is started, it will start the edit box input event monitor module in the plug-in apparatus. The plug-in apparatus realizes enlargement of the edit box in the mobile application for presentation, thereby improving the information input speed of the mobile terminal. The apparatus will be described in detail below in conjunction with FIGS. 2 and 3.

FIG. 2 is a block diagram of a setting part of an apparatus for enlarging a mobile application edit box based on event monitor according to an embodiment of the present document. As shown in FIG. 2, the setting part of the apparatus comprises a local amplification module and an amplification factor configuration module.

The local amplification module is used to preset a local amplification proportion, which is supplied to the edit box redrawing module to amplify the native interface according to the local amplification proportion, to obtain a redrawn and amplified interface. That is, the local amplification module is used to set an amplification proportion of the redrawn and amplified interface, i.e., configuring the proportion of the screen of the mobile terminal which is occupied by the new amplified interface of the edit box. The local amplification module configures a size of the redrawn and amplified interface when the original mobile application edit box is clicked. The module may be configured by the user. When the module is not configured by the user, the size of the redrawn and amplified interface is a screen which occupies the whole mobile terminal by default.

The amplification factor configuration module is used to preset an input amplification proportion, which is supplied to the edit box redrawing module to amplify the original mobile application edit box and/or font and/or touch keyboard in the redrawn and amplified interface according to the input amplification proportion, to form an information input interface. That is, the amplification factor configuration module is used to configure the amplification proportion of the edit box in the redrawn and amplified interface and/or font in the edit box and/or the touch keyboard. The proportion may be set by the user himself/herself. If the proportion is not set by the user, the amplification proportion of the redrawn and amplified interface will be adapted to select a suitable proportion for amplification.

FIG. 3 is a block diagram of an enlarging part of a system for enlarging a mobile application edit box based on event monitor according to an embodiment of the present document. As shown in FIG. 3, an edit box input event monitor module, an edit box redrawing event monitor module, and an edit box data interaction module are comprised.

The edit box input event monitor module is used to monitor the user input event of the mobile application edit box, and intercept the event. Further, after the operating system of the mobile terminal is started, the operating system will automatically invoke the original mobile application edit box input event monitor module, and monitor and intercept an event of a user clicking on the original mobile application edit box through the mobile application edit box input event monitor module, and trigger the edit box redrawing event monitor module.

The edit box redrawing event monitor module is used to newly create the native interface of the mobile application after the edit box input event monitor module monitors and intercepts the user input event, and amplify and redraw the original mobile application edit box in the native interface, to obtain a new mobile application edit box suitable for user input, which is supplied to the user to input information. Further, after creating the native interface of the mobile application, the edit box redrawing event monitor module implements an amplifying process on the native interface, to obtain a redrawn and amplified interface, and implements an amplifying process on the edit box and/or font and/or touch keyboard in the redrawn and amplified interface, to form an information input interface suitable for user input, which is supplied to the user to input information. That is, the edit box redrawing event monitor module redraws the original mobile application edit box and the touch keyboard in the newly created native interface in proportion.

The edit box data interaction module is used to rewrite the user input information in the original mobile application edit box after the user completes the information input. That is, the edit box data interaction module rewrites the user input data in the redrawn interface into the original mobile application edit box.

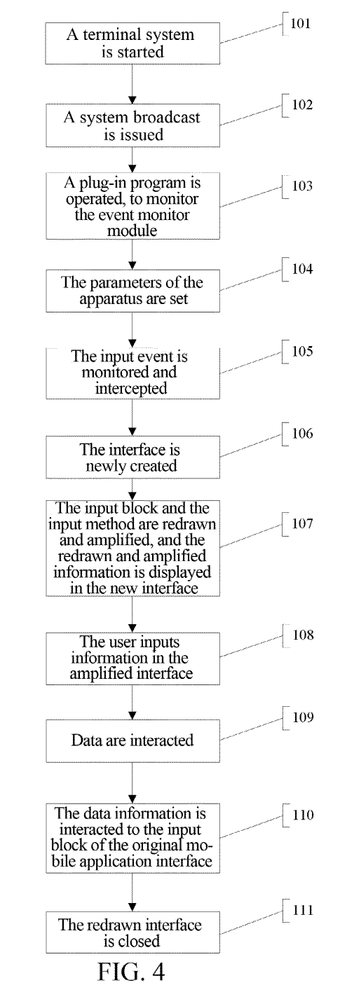

FIG. 4 is a flowchart of an apparatus for enlarging a mobile application edit box based on event monitor according to an embodiment of the present document. As shown in FIG. 4, the following steps are comprised.

In step 101, an operating system of a mobile terminal is started.

In step 102, the system issues a system broadcast with contents of ACTION_BOOT_COMPLETED.

In step 103, when the system broadcast is captured, an edit box input event monitor module is started and operated.

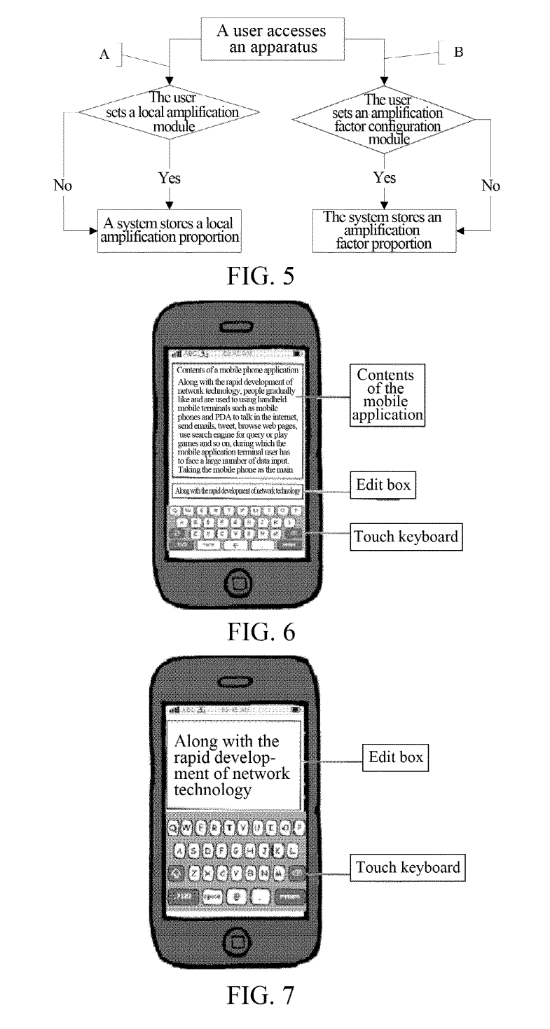

In step 104, the user may access the setting part in the apparatus, and the specific setting steps may be known with reference to the flowchart of the operation of the setting part illustrated in FIG. 5.

In step 105, when the user clicks on the original mobile application edit box, the edit box input event monitor module will automatically monitor and intercept the user input event, and invoke the edit box redrawing event monitor module.

In step 106, the edit box redrawing event monitor module firstly automatically newly creates a native interface of a mobile application, and enlarges the native interface according to a local amplification proportion previously preset by a user, to obtain a new native interface of the mobile application, i.e., redrawing the amplified interface, which is supplied to the user to input information.

In step 107, in the redrawn and amplified interface, the amplifying and redrawing event monitor module will firstly calculates an amplification proportion of the redrawn and amplified interface according to an adaptive algorithm, and adaptively amplifies and redraws the original mobile application edit box and the touch keyboard (the amplification factor is decided according to the preset input amplification proportion) in the redrawn and amplified interface, to obtain new mobile application edit box and touch keyboard, and display the amplified and redrawn information in the amplified native interface of the mobile application.

In step 108, the user inputs information in the new mobile application edit box using the touch keyboard.

In step 109, an edit box data interaction module is invoked.

In step 110, the edit box data interaction module interacts the data information input by the user in the new mobile application edit box in the original mobile application edit box.

In step 111, the redrawn interface is automatically closed, and the data interaction process is completed.

FIG. 5 is a flowchart of operations of a setting part according to an embodiment of the present document. As shown in FIG. 5, the following steps are comprised.

The process A is that the user accesses the plug-in apparatus and sets a local amplification module. If the module has been preset by the user, the plug-in apparatus will amplify the amplified interface of the edit box using the preset local amplification proportion, i.e., amplifying the newly created native interface. If the module has not been preset by the user, the plug-in apparatus will use a default value, to set the amplification proportion of the amplified interface of the edit box to the whole screen of the terminal.

The process B is that the user accesses the plug-in apparatus and sets an amplification factor configuration module. If the module has been preset by the user, the plug-in apparatus will amplify the edit box, the font and the touch keyboard using the preset input amplification proportion. If the module has not been preset by the user, the plug-in apparatus will use a default value, to adaptively amplify the edit box, the font and the touch keyboard in the amplified interface according to the proportion of the amplified interface.

FIG. 6 is a presentation diagram of an edit box in a mobile application in the current stage according to an embodiment of the present document; and FIG. 7 is a diagram of an effect after a terminal invokes the plug-in for redrawing according to an embodiment of the present document. It can be clearly seen from the figures that the redrawn information input interface is easier for information input, and at the same time, the contents input by the user can be clearly displayed.

Further, the plug-in apparatus also well supports the text field and the search box in the mobile application.

In addition, the present document further provides a mobile terminal, which comprises the above apparatus for enlarging a mobile application edit box based on event monitor.

In conclusion, the present document has the following technical effects:

The present document redraws the original edit box of the mobile application in the new interface, which effectively solves the problem of difficulty in input due to an extremely small edit box in the mobile application, and largely improves the user experience of data input in the edit box.

Although the present document is described in detail above, the present document is not limited thereto. Those skilled in the art can make various modifications according to the principle of the present document. Therefore, any modification, which is made according to the principle of the present document, should be construed to fall in the protection scope of the present document.

### INDUSTRIAL APPLICABILITY

The embodiments of the present document makes great improvement in the experience of information input in the edit box, achieves the effect of displaying input information in the edit box, saves the time for the user to input information and improves user experience of information input.

What is claimed is:

1. A method for enlarging a mobile application edit box based on event monitor, comprising:
after monitoring and intercepting a user input event of an original mobile application edit box, a mobile terminal newly creating an native interface of the mobile application; and
enlarging and redrawing the original mobile application edit box in the native interface to obtain a new mobile application edit box suitable for user input, which is supplied for a user to input information.

2. The method according to claim 1, further comprising:
implementing an enlarging process on the native interface according to a preset local enlargement proportion.

3. The method according to claim 1, further comprising:
implementing enlarging and redrawing processes on the original mobile application edit box in the enlarged native interface according to a preset input enlargement proportion.

4. The method according to claim 3, wherein, if the input enlargement proportion is not preset, implementing adaptive enlarging and redrawing processes on the original mobile application edit box according to the enlarged native interface.

5. The method according to claim 4, further comprising:
implementing enlarging and redrawing processes on a touch keyboard for information input and/or a font of information input by the user in the new mobile application edit box according to the input enlargement proportion or the enlarged native interface.

6. The method according to claim 1, further comprising:
rewriting the user input information in the new mobile application edit box into the original mobile application edit box and closing the native interface.

7. An apparatus for enlarging a mobile application edit box based on event monitor, comprising:
an edit box input event monitor module, configured to monitor and intercept a user input event of a mobile application edit box; and
an edit box redrawing event monitor module, configured to, after monitoring and intercepting the user input event, newly create an native interface of the mobile application, enlarge and redraw the original mobile application edit box in the native interface to obtain a new mobile application edit box suitable for user input, which is supplied for a user to input information.

8. The apparatus according to claim 7, wherein, the edit box redrawing event monitor module is further configured to implement an enlarging process on the native interface according to a preset local enlargement proportion.

9. The apparatus according to claim 7, wherein, the edit box redrawing event monitor module is further configured to implement enlarging and redrawing processes on the original mobile application edit box and/or a touch keyboard and/or a font according to the preset input enlargement proportion or the enlarged native interface.

10. The apparatus according to claim 7, further comprising:
an edit box data interaction module, configured to rewrite the user input information in the new mobile application edit box into the original mobile application edit box and close the native interface.

11. The method according to claim 2, further comprising:
implementing enlarging and redrawing processes on the original mobile application edit box in the enlarged native interface according to a preset input enlargement proportion.

12. The method according to claim 11, wherein, if the input enlargement proportion is not preset, implementing adaptive enlarging and redrawing processes on the original mobile application edit box according to the enlarged native interface.

13. The method according to claim 12, further comprising:
implementing enlarging and redrawing processes on a touch keyboard for information input and/or a font of information input by the user in the new mobile application edit box according to the input enlargement proportion or the enlarged native interface.

14. The method according to claim 2, further comprising:
rewriting the user input information in the new mobile application edit box into the original mobile application edit box and closing the native interface.

15. The apparatus according to claim 8, wherein, the edit box redrawing event monitor module is further configured to implement enlarging and redrawing processes on the original mobile application edit box and/or a touch keyboard and/or a font according to the preset input enlargement proportion or the enlarged native interface.

16. The apparatus according to claim 8, further comprising:
an edit box data interaction module, configured to rewrite the user input information in the new mobile application edit box into the original mobile application edit box and close the native interface.
